(19) United States
(12) Patent Application Publication
(10) Pub. No.: US 2005/0258149 A1
(43) Pub. Date: Nov. 24, 2005

(54) Method and apparatus for manufacture of nanoparticles

(76) Inventors: Yuri Glukhoy, Irwin, PA (US); Gotze Popov, Irwin, PA (US); Junhai Liu, N. Huntingdon, PA (US); Anit Giri, Pittsburgh, PA (US)

Correspondence Address: Yuri Glukhoy, 1061 Main Street, North Huntingdon, PA, 15642, US

(21) Appl. No.: 10/851,827

(22) Filed: May 24, 2004

(51) Int. Cl. B23K 9/00

(52) U.S. Cl. 219/121.48

(57) ABSTRACT

A method and apparatus for manufacturing nanoparticles by passing a carrying fluid with a nanoparticle precursor through an RF plasma volume for heating the fluid with a nanoparticle precursor to a high temperature sufficient to synthesizing the nanoparticles. The suspension of the fluid with nanoparticles is passed to the thermalization zone in a diverging portion of the Laval nozzle for subjecting the fluid with nanoparticles to jumpwise adiabatic expansion at the exit from the converging portion of the Laval nozzle to the thermalization zone. At least the diverging portion has a curvilinear profile optimized with respect to conditions of said thermalization. In the thermalization zone, the flow of fluid with nanoparticles is surrounded by a cylindrical oil shower composed of discrete drops of oil. The oil shower is emitted from a shower ring that performs twisting motions. The particles are entrapped in the oil drops while the fluid is allows to pass in the radial outward direction from a portion of the thermalization zone. The oil drops with entrapped nanoparticles are collected and loaded into cups with the use semi-automatic or automatic mechanism.

### FIELD OF THE INVENTION

The present invention relates to the field of production of special materials, in particular to a method and apparatus for manufacturing nanoparticles that may be used in a wide range of applications and industries. More specifically, the invention relates to a method and apparatus for manufacturing nanoparticles of materials of a high melting point, such as metals oxides, e.g., ceramics.

### BACKGROUND OF THE INVENTION

Nanoparticles, which are also known as ultradispersed powders with a size in nanometer scale, usually below 100 nm, normally comprise particles of chemical elements such as carbon, silicon, gold, iron, etc. or particles of simple compounds such as silicon-germanium compounds, aluminum oxides, silicon nitrides, etc., as well as particles that form aggregates of two or more compounds (Si/C/N, Si₃N₄/SiC). Nanoparticles find application in such diverse fields as cosmetics, coatings, polishing and catalysis, which all require that the particles be initially well dispersed and that the particles stay well dispersed (i.e. do not aggregate or “crash out” in the application environment) in order to exhibit their full activity. In order to preserve their properties intact, nanoparticles are stored dispersed in a chemically neutral liquid such water and a variety of polar and non-polar organic fluids, e.g., oils. This allows the nanoparticle manufacturers to supply them in a concentrated, ready-to-use dispersion forms, eliminating the need for customers to disperse the nanoparticles themselves. This capability proves particularly attractive to customers who lack the equipment to prepare dispersions or wish to avoid handling dry powders.

In the case of aqueous dispersions, the electrostatic requirements to the dispersion stability can be achieved at the particle surface using processes that are known as the PVS (Physical Vapor Synthesis) or NAS (NanoArc™ Synthesis) processes. These processes are described in the materials of Nanophase Technologies Corporation, Romeoville, Ill. In the case of polar and non-polar organic fluids, nonionic steric stabilizers are employed. These dispersants prevent the nanoparticles from forming larger aggregates through repulsive forces extending from the particle-continuous phase interface. Using this technology, it is possible to prepare stable dispersions of the nanoparticles in most common organic solvents and resin systems.

The nanoparticles that may be most interesting for practical application are those having dimensions within the range from nanometers to several tens of namometers. In physics, particles of such small dimensions are known as clusters. A cluster is an aggregate of atoms or molecules generally intermediate in size between individual atoms and aggregates large enough to be called bulk material. As a rule, in a cluster the compounds of different nature are held together under the effect of van der Waals forces. Since the properties of clusters are dependent on their size, they have been the objects of research activity for many years. One such known extraordinary property of nanoparticles is their enormous specific surface area. It is understood that this property may be especially important when nanoparticles are used as components of surface-active agents since in this case such agents demonstrate an extraordinary activity, e.g., activity in oxidation that under certain conditions may cause an explosion. Less known property of nanoparticles is a sharp change in properties of some materials under effect of introduction of nanoparticles into the material matrix when the nanoparticles exert strong influence on the grain interfaces. This property is used, e.g., in the development of new structural materials with improved mechanical, thermal, and chemical properties.

This is achieved by conducting chemical reactions of decomposition and/or synthesis directly in a volume of a gaseous phase and under conditions of nucleation (formation of clusters) of solid-phase products in the zone of reaction.

Given below is a description of some known methods used for manufacturing of nanoparticles.

In accordance with the technology of the aforementioned company Nanophase Technologies Corporation, nanoparticles are produced by the aforementioned PVS process, which is a multiple-step process that consists, mainly, of several sequential steps that can be roughly combined into sputtering, thermalization, and clustering. In the sputtering step, a solid precursor (typically metal) is fragmented to molecular-size particles, which comprise a high temperature vapor of the aforementioned precursor material. In the thermalization step, a reactant gas is added to the vapor, which is then cooled at a controlled rate and condenses at the clustering step to form nanoparticles. The nanoparticles that can be produced by the PVS process may comprise discrete, fully-dense particles of defined crystallinity. Typically, the particles produced by this method have an average sizes ranging from 8-75 nm. Nanophase Technologies uses the PVS process in the commercial scale production of NanoGard® Zinc Oxide and NanoTek® Aluminum Oxide. In addition, this process has been used to generate additional materials such as a variety of doped zinc oxides, selected rare earth, transition metal oxides, and transparent conductive oxides such as antimony-tin oxide and indium-tin oxide.

In the aforementioned NAS process, similar to the PVS, the arc energy is used to produce nanoparticles. The NAS process, however, is capable of using a wide variety precursor formats and chemical compositions, thereby expanding the number of materials that can be manufactured as nanopowders at industrial scale. The nanomaterials produced by the NAS process also consist of discrete, fully-dense particles of defined crystallinity. This method has been used to produce particles with average sizes ranging from 7-45 nm. An enhanced capability of the NAS process is its ability to process complex multi-component materials. This process has demonstrated the ability to produce homogeneous mixed metal oxide nanopowders where the component materials form solid solutions with well-defined single crystalline phases. Nanocrystalline metal oxides having up to four metallic elements have been produced.

Another example that illustrates manufacturing of nanoparticles in chemical reactions of decomposition and/or synthesis directly in a volume of a gaseous phase and under conditions of nucleation (formation of clusters) of solid-phase products in the zone of reaction, is a laser synthesis of nanoparticles. One typical scheme of manufacturing ultra-dispersed powders is a process described by Borsella E., et al. in: “Laser Synthesis and Characterization of Ceramic Nanocomposite Powders”, Report of ENEA, Rome, Italy, 1993. The process is carried out by using continuous-mode CO₂ laser having a power of 1 to 2 kWt. The laser beam is focused to a 2-4 mm light spot. The focus point is located on the output of the working gas injector. The working gas may comprise a mixture of gases. The working gas mixture is supplied to a reactor in a flow of inert gas, e.g., argon. A thermochemical reaction that results in the formation of nanoparticle clusters occurs at the focal point. The nanoparticles produced in the reactor are evacuated from the reactor by means of vacuum and are collected in a special collection reservoir. Under optimal conditions the aforementioned apparatus may produce 10 to 100 g/hr of microparticles of the following materials: 1) one-component materials (Si, C); 2) simple compounds (SiC, Si₃N₄, Al₂O₃); 3) binary powders (SiC+Si₃N₄); 3) three-component powders (Si/C/N). The nanoparticles are obtained with dimensions from 5 to 100 nm. The synthesis temperatures vary in the range of 800 to 2500° C.

A disadvantage of the above system is low efficiency and significant losses of nanoparticles during evacuation from the reactor.

Another example of nanoparticle generation is a Laser Ablation of Microparticles (LAM) process, which is now used for making nanoparticles of a wide variety of materials (metals, semiconductors, and dielectrics). In the LAM process, a high-energy laser pulse hits a microparticle (typically 2-20 μm dia.), initiating breakdown and shock-wave formation. A source of light energy used in the process may comprise lasers of various types such as eximer lasers such as Kr—F, Ar—F lasers, solid-state lasers such as YAG lasers, etc. As the shock passes through the microparticle, it converts a high percentage of the mass to nanoparticles (20-100 nm dia). Since the nucleation of nanoparticles follows the shock as a traveling wave, it is energetically efficient because the absorbed laser energy is only about 10% of the microparticle's heat of vaporization.

LAM process is distinguished by nanoparticle distributions with a controllable mean diameter and a small dispersion (standard deviation/diameter) compared to nanoparticles generated by other processes, especially laser ablation from flat solid surfaces. The LAM process nanoparticles has the following distinguishing features: they (1) are narrowly distributed in diameter, (2) have a mean diameter that can be controlled, (3) are pure as the feedstock material, (4) preserve composition of the feedstock material, (5) are non-agglomerated, (6) can produce nanoparticles of virtually all solids, and (7) can be scaled to the production of large quantities. The process makes it possible to limit the particle size deviation by 20% or less. Further size selection process makes it possible to reduce the size deviation to 5%.

The apparatus comprises a column that contains the following units arranged sequentially: an aerosol feed source; a working chamber which, in addition to aerosol, is also supplied with a buffer gas; a virtual impactor size filter; and a nanoparticle collector. Microparticles are captured in a stream of gas at atmospheric pressure in the powder-aerosol generator that produces a sufficient particle number density (e./g., ˜10⁸ cm⁻³) to absorb a significant fraction of the excimer laser energy (248 nm). To maintain laminar flow in the laser interaction cell and to provide a windowless design for the laser, the aerosol may be focused by a flowing boundary gas after it leaves the nozzle. The laser light is brought to an elliptical focus at the end of the nozzle. Though the laser is pulsed, the laser repetition rate, the aerosol velocity, and the laser focal width down-stream are controlled so that microparticles just refill the focal volume in the time between laser shots. The nanoparticles are separated by a skimmer and sent though a filter (virtual impactor) that separates any unablated or larger particles from the desired nanoparticle flow. This is particularly useful for materials that may produce bimodal size distributions.

The LAM process makes it possible to produce nanoparticles having a diameter of 5 to 10 nm. However, the process has low efficiency that normally does not exceed 10 g/hr. Therefore the LAM process is not yet ready for cost-effective commercial application.

In principle, the aforementioned sputtering as the initial aerosol formation step of the LAM process can be replaced by the generation of particles directly from a gaseous phase. Normally, this step is accompanied by a chemical reaction for obtaining a specific substance from which the nanoparticles are to be formed.

The process and equipment for realization of the aforementioned processes are described, e.g., in U.S. Patent Application Publication No. 20030143153 filed by M. Boulos, et al. in 2002 and entitled “Plasma synthesis of metal oxide nanopowder and apparatus therefor”. This invention also reflects a new trend in the development of methods and apparatuses for manufacturing nanoparticles in a process where thermalization is carried out by rapidly expanding the flow of particles in a mixture with carrying gas after exit from a nozzle.

The aforementioned publication describes synthesis of a metal oxide nanopowder from a metal compound vapor, in particular, a process and apparatus for the synthesis of TiO₂ nanopowder from TiCl₄. The metal compound vapor is reacted with an oxidizing gas in electrically induced RF frequency plasma thus forming a metal oxide vapor. The metal oxide vapor is rapidly cooled using a highly turbulent gas quench zone, which quickly halts the particle growth process, yielding a substantial reduction in the size of metal oxide particles formed. The metal compound vapor can also react with a doping agent to create a doped metal oxide nanopowder. Additionally, a process and apparatus for the inline synthesis of a coated metal oxide is disclosed wherein the metal oxide particles are coated with a surface agent after being cooled in a highly turbulent gas quench zone.

More specifically, a titanium dioxide nanopowder is manufactured by heating titanium tetrachloride to a reaction temperature using an induction plasma, reacting the obtained titanium tetrachloride vapor with an oxidizing gas to form titanium dioxide vapor, and rapidly cooling the titanium dioxide vapor to promote homogeneous nucleation of a fine aerosol and stop the growth process of the resulting particles.

An apparatus for realization of the aforementioned process comprises a reactor and a filter unit. The reactor has a vertically disposed generally tubular chamber section closed at the upper end by an induction plasma jet assembly.

The working gas is formed of a mixture of oxygen and argon (with oxygen also acting as the oxidizing agent). Oxygen is introduced into the reactant mixing chamber via a first inlet and argon via a second inlet. A high frequency electric current is applied to the inductive coil; the power level of this electric current is sufficiently high to ionize the oxygen/argon mixture and create the plasma. The minimum power level applied to the inductive coil necessary for self-sustained induction plasma discharge is determined by the gas, pressure, and frequency of the magnetic field. The minimum power necessary for sustaining an induction plasma discharge may be lowered by reducing the pressure or by adding ionizing mixtures. Power can vary from 20 to 30 kW all the way up to hundreds of kilowatts depending on the scale of operation. The frequency of the current supplied to the inductor coil can be of the order of 3 MHz, although successful operation can be demonstrated at typical frequencies as low as 200 kHz.

The process involves a high intensity turbulent quenching technique which is required for ultra rapid cooling of the products of the reaction and the hindrance of the particle growth process normally associated with the formation of aerosol particles through vapor condensation. The rapid quenching technique contributes to the formation of the nanopowder and the predominance (experimental results reveal over 80%) of the anatase phase in this powder. A highly turbulent gas quench zone is produced by injecting an intense turbulent stream of compressed quench gas into the plasma discharge. This is made via coplanar fine quench gas nozzles oriented in respective directions having both radial and tangential components to produce respective high speed jets of quench gas in the same radial/tangential direction. In fact, a provision of high-speed jets in the reactor forms a virtual Laval nozzle.

In the lower part, the reactor has a downwardly tapered section which is connected via a conduit to the filter unit. The filter unit is comprised of an upper, vertically disposed generally tubular section and a taper section mounted on the lower end of the generally tubular section. This tapered portion defines a region for collecting the filtered titanium dioxide nanopowder. A porous filter medium, such as Goretex™, capable of capturing the nanopowder, is mounted axially and centrally within the generally tubular section and has porosity such that the nanopowders cannot pass there through and are removed from the exhaust gases which are expelled via the exhaust. Nanopowder received in the aforementioned region is collected through a bottom vertical conduit connected to the tapered region.

In spite of all the advantages of the above-described process and apparatus that make them suitable for industrial application, they still entail some drawbacks. First, the nozzle, which is used for expansion of the flow of gas with particles at the exit from the nozzle to the thermalization zone, has some thermalization limitations resulting from a subsonic structure of this nozzle. A system used for collection of the particles excludes collection of active nanoparticles. Therefore, the method and apparatus described above may be inapplicable for a wide range of nanoparticle productions.

A series of U.S. Patents (No. RE37,853E, U.S. Pat. No. 6,395,197, U.S. Pat. No. 6,187,226, U.S. Pat. No. 5,935,293, and U.S. Pat. No. 5,749,937) issued to B. A. Detering, et al. relate to methods and apparatuses for a fast quench reaction that is carried out in a reactor chamber having a high temperature heating means such as a plasma torch at its inlet and means of rapidly expanding a reactant stream, such as a restrictive convergent-divergent nozzle (Laval nozzle) at its outlet end. Reactants are injected into the reactor chamber. Reducing gas is added at different stages in the process to form a desired end product and prevent back reactions. The resulting heated gaseous stream is then rapidly cooled by expansion of the gaseous stream. The reactor chamber has a predetermined length sufficient to effect heating of the reactant stream to a selected equilibrium temperature at which the desired end product is available within the reactant stream as a thermodynamically stable reaction product at a location adjacent to the outlet end of the reaction chamber. The gaseous stream is passed through the aforementioned Laval nozzle arranged coaxially within the remaining end of the reactor chamber to rapidly cool the gaseous stream by converting thermal energy to kinetic energy as a result of adiabatic and isentropic expansion as it flows axially through the nozzle and minimizing back reactions. This retains the desired end product within the flowing gaseous stream. The obtained particles are cooled and the speed of the flow is reduced for removing the remaining gaseous stream exiting from the nozzle. Preferably the rapid heating step is accomplished by introducing a stream of plasma arc gas to a plasma torch at the inlet end of the reactor chamber to produce plasma within the reactor chamber, which extends toward its outlet end.

In general, all aforementioned patents are based on the same principle and differ by improvements in the profiles and geometry of the Laval nozzle, in particular a divergent angle that vary from 6 to 35 degrees.

An alternate method described in U.S. Pat. No. 5,935,293 discloses a virtual Laval nozzle, similar to the one mentioned in U.S. Patent Application Publication No. 2003/0143153, accomplished by directing one or more streams of particles, droplets, liquid, or gas into the main flow stream of the reaction chamber such that the main reactant flow stream is forced to flow as though a real convergent-divergent nozzle were present. This phenomenon occurs because the reduced axial momentum of the directing flow effectively impedes the flow of the main stream, thereby forcing the majority of the main stream to flow around the impeding stream, similar to the flow through the restriction of a conventional converging-diverging nozzle.

U.S. Pat. No. 5,851,507 issued in 1998 to S. Pirzada describes an integrated thermal process for the continuous synthesis of nanoscale powders from different types of precursor material by evaporating the material and quenching the vaporized phase in a converging-diverging expansion nozzle. The precursor material suspended in a carrier gas is continuously vaporized in a thermal reaction chamber under conditions that favor nucleation of the resulting vapor. Immediately after the initial nucleation stages, the vapor stream is rapidly and uniformly quenched at rates of at least 1,000 K/sec, preferably above 1,000,000 K/sec, to block the continued growth of the nucleated particles and produce a nanosize powder suspension of narrow particle-size distribution. The nanopowder is then harvested by filtration from the quenched vapor stream and the carrier medium is purified, compressed and recycled for mixing with new precursor material in the feed stream.

A common disadvantage of the methods and apparatuses disclosed in aforementioned patents of Detering, et al. and S. Pirzada is that the diverging portions of the Laval nozzles proposed in these patents have linear tapered profiles and are not optimized with regard to temperatures required for ultra-rapid thermalization of the produced nanoparticles. As a result, the nanoparticles produced with the use of known nozzles are obtained with a relatively large dispersion of particle dimensions.

Another disadvantage of the aforementioned methods and apparatuses is an imperfect system used for collecting the produced nanoparticles. Such imperfect system of nanoparticle collection significantly limits the scope of possible practical applications for manufacturing nanoparticles of some specific types.

### OBJECTS AND SUMMARY OF THE INVENTION

It is an object of the present invention to provide an apparatus for manufacturing nanoparticles that is characterized by improved conditions for the formation of nanoparticles and for collection of the produced nanoparticles. It is another object is to provide the apparatus of the aforementioned type which is characterized by nanoparticles that can be produced in a wide range of types and dimensions. A further object is to provide an apparatus of the aforementioned type, which is characterized by high production efficiency and is suitable for use under industrial conditions. Still a further object is to provide the apparatus of the aforementioned type, which is capable of producing and encapsulating active nanoparticles in a state ready for subsequent use. A further object is to provide a method of manufacturing nanoparticles in a wide range of dimensions and types with high production efficiency.

The apparatus consists of the following units sequentially arranged in the direction of propagation of the particles: a DC plasma torch initiator into which components of the working mixture are supplied; an RF reactor for generation of plasma used for the formation of nanoparticles; a Laval nozzle section for thermalization and quenching of the nanoparticles; and a product collection unit for collecting the obtained nanoparticles in oil and for dispensing the oil/particle suspension into containers. The apparatus of the invention differs from similar apparatuses of this type by the following features: 1) the DC plasma torch initiator generates a high-pressure plasma (1.2 to 3 atm); 2) the RF plasma reactor that operates on two different frequencies has an elongated shape and sustains the ignited plasma under the increased pressure over the entire length of the reactor; 3) the Laval nozzle has a special profile optimized with respect to the quenching process; 4) the Laval nozzle is provided at its outlet end with a device for forming a twisted oil shower that surrounds the flow of the working mixture and that entraps and collects the nanoparticles contained in this mixture, while allows the gas to pass through the oil barrier to the evacuation system; 5) the apparatus is provided with a system for automatically dispensing the oil/nanoparticle suspension into storage containers, this system being connected to the product collection unit; 6) the apparatus is suitable for operation in a continuous mode.

### BRIEF DESCRIPTION OF THE DRAWINGS

FIG. 1 is a general three-dimensional view of the apparatus of the invention for manufacturing nanoparticles.

FIG. 2 is a longitudinal sectional view of the apparatus of the invention in a plane perpendicular to the axis Z-Z of FIG. 1.

FIG. 3A is a view that illustrates a profile of the nozzle used in the apparatus of the present invention.

FIG. 3B is a view that is used for explaining the method for optimization of the nozzle profile.

FIG. 4 is a sectional view of the apparatus in the X-Z plane of FIG. 1.

FIG. 5 is more detailed view of a nanoparticle entrapment unit.

FIG. 6 is a sectional view along the line VI-VI of FIG. 5.

FIG. 7 is a three-dimensional view of a rotary reciprocation drive mechanism for swinging the oil shower ring.

### DETAILED DESCRIPTION OF THE INVENTION

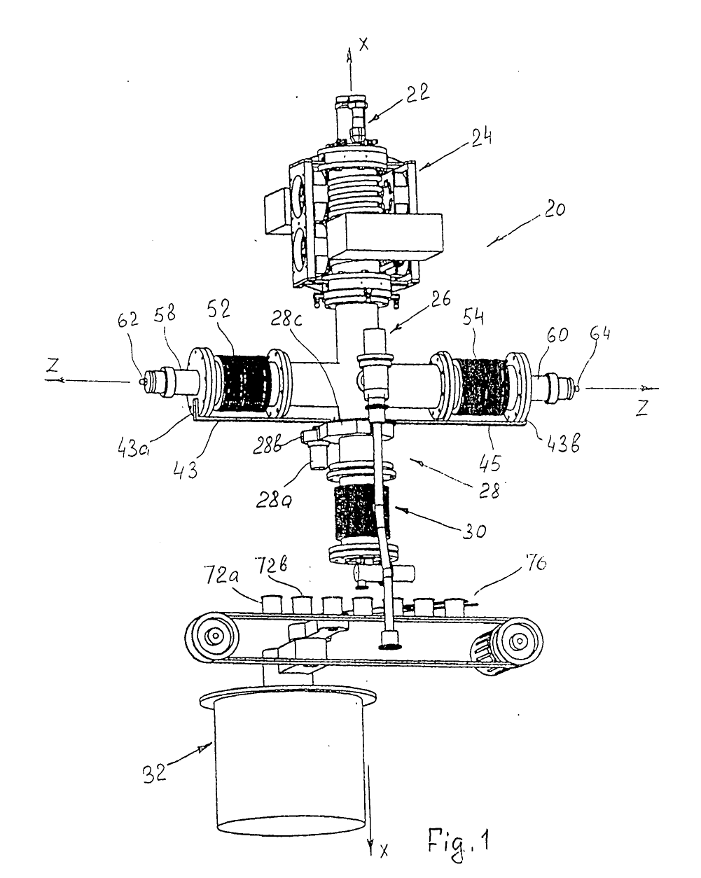

FIG. 1 is a general three-dimensional view of the apparatus of the invention for manufacturing nanoparticles. The apparatus as a whole is designated by reference numeral 20 and consists of the following main units sequentially arranged in the direction of propagation of the particles: a DC plasma torch initiator 22 into which components of the working mixture (nanoparticle precursor) are supplied; an RF plasma reactor 24, where the plasma chemical reactions for the initiation of the nanoparticle formation from a precursor occur; a Laval nozzle section (only a housing 26 of this section is shown in FIG. 1) for fast quenching and finishing the nanoparticle synthesis at well defined temperature (this process is also known as thermalization); a nanoparicle shielding and ntrapmnt unit 28, which is associated with the outlet end of the Laval nozzle (only rotary reciprocation drive motor 28a with the drive gear 28b and the protective casing 28c of the gear wheel are shown in FIG. 1); a product collection unit 30 for collecting the obtained nanoparticle suspension; and a mechanical robot 32 for dispensing the (oil/particle suspension) into containers.

Now each of the aforementioned main units will be considered individually in more details.

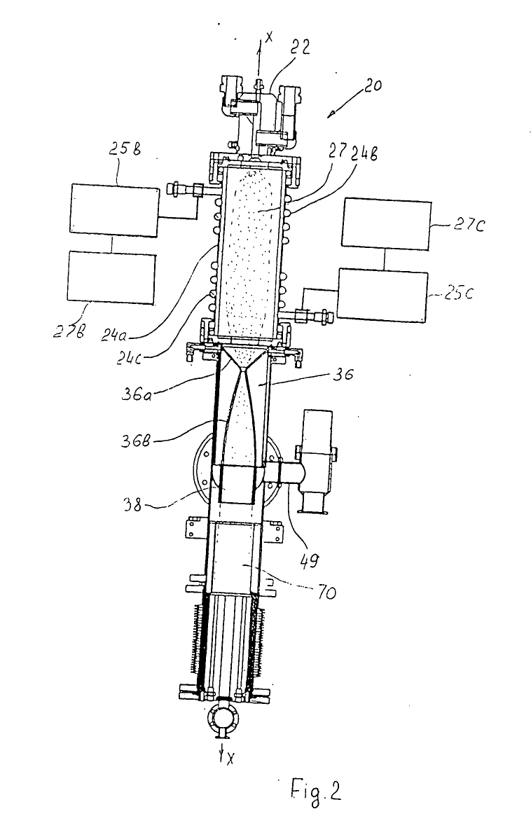

FIGS. 1 and 2—DC Plasma Torch Initiator

The DC plasma torch initiator 22 is shown in FIG. 2, which is a longitudinal sectional view of the apparatus 20 of the invention in a plane perpendicular to the axis Z-Z of FIG. 1. The DC plasma torch initiator 22 is intended for (ignition of the plasma torch) in the RF plasma reactor 24 that will be described later. The DC plasma torch initiator 22 may comprise a commercially available device such as a thermal spray gun SG-100 produced by Thermach Inc., Appleton, Wis., USA. In fact, the DC plasma torch initiator is a plasmotron having a cylindrical body that functions as an anode, the distal end of which is formed as a nozzle with tapered walls. The tungsten cathode (not shown) with an axial channel for the supply of a working medium, e.g., an aqueous solution of a precursor for the formation of nanoparticles, or a mixture of different gases capable of chemically reacting at high temperatures for the formation of nanoparticle substances is mounted on the axis of the plasmotron. The anode is mounted coaxially to the cathode. The distant end of the anode is formed as a nozzle with tapered walls. A buffer gas, e.g., argon, is supplied to the space between the cathode and anode. A specific feature of the DC plasma torch initiator 22 of the apparatus of the present invention is that it operates under a high pressure of the working medium. With an applied potential difference between the anode and the cathode, an arc discharge is ignited by a HV spark igniter and sustained as a jet popping out of (in) the tapered nozzled portion of the anode. When the working medium passes through the arc-discharge area, it is heated to a high temperature, ionized, and injected into the RF plasma reactor 24 (FIGS. 1 and 2). Since the cathode is at a very high temperature, the working medium such as an aqueous solution is instantly evaporated, and the material that is supplied from the arc-formation zone to the RF reactor 24 is in the form of aerosol. The buffer gas such as argon has a low coefficient of ionization and therefore facilitates formation of the arc.

FIGS. 1 and 2—RF Reactor

The RF plasma reactor 24 (FIGS. 1 and 2) has a cylindrical body 24a made from a dielectric material of high thermal resistance, e.g., ceramic or quartz, and supports two inductive winding 24b and 24c wound around the cylindrical body 24 for excitation of an RF plasma inside the cylindrical body 24a. Each winding or RF antenna 24b and 24c dissipates power of about 50 kW in the form of an electromagnetic field and Joule heat. Therefore the windings are made from water-cooled copper pipes of appropriate geometry capable of withstanding the aforementioned power loads. In order to exclude undesired interference between the concurrent electromagnetic fields, the windings 24b and 24c operate on different frequencies. For example, the winding 24b can operate on a frequency of 13.56 MHz, while the winding 24c can operate on a frequency of 27.12 MHz. Reference numerals 25b and 25c designate matching devices for matching the windings or antennas 24b and 24c with respective power supplies 27b and 27c. Thus, an RF plasma 27 is generated inside the cylindrical body 24a. The plasma 27 is sustained inside the cylindrical body 24a under a pressure of about 2.5 atm. At this pressure the plasma is in thermodynamic equilibrium and the gaseous temperature in the center of the plasma volume (plasma) may reach 10000° C. The main function of the plasma 27 is to form nanoparticles from molecules of the precursor. In order to fix the nanoparticle dimensions, i.e., to inhibit their growth after they reached a desired dimension, it is necessary to change thermal conditions in a jumpwise manner. This is achieved in the next stage of the apparatus, i.e., in the Laval nozzle section 36 (FIGS. 1 and 2).

FIGS. 1 and 2—Laval Nozzle Section

Since long ago, nozzles find wide application in chemical processes for creation of molecular beams, in high jet apparatuses, in blowing processes, etc. As has been shown above in the patent publications mentioned in the section “Background of the Invention”, the Laval nozzles and virtual Laval nozzles were used for fast quenching required for discontinuing the growth of nanoparticles. The super fast quench phenomena observed in the reactors was achieved by rapidly converting thermal energy in the gases to kinetic energy via a modified adiabatic expansion.

This function is achieved through the use of the aforementioned Laval nozzle, which now will be considered in more detail.

In a nozzle, the speed of liquid or gas that passes through the nozzle constantly increases in the direction of flow from an initial value v₀ (which normally is low) at the nozzle inlet to a maximal velocity vₙ at the nozzle outlet. During movement through the nozzle, the internal energy of the working medium is transformed into kinetic energy of the outlet stream, the reactive force of which, known as thrust, has a direction opposite to that of the outgoing stream. This property is used in reactive jet engines. However, the present invention is based on other properties of the nozzles which are considered below. In accordance with the law of conservation of energy, the increase in speed is accompanied by continuous drop of pressure and temperature from their initial values p₀, T₀ at the nozzle inlet to their lowest values pₙ, Tₙ at the nozzle outlet. Thus, in order to realize a flow of the medium in a nozzle, a certain pressure drop is required, i.e., the following condition should be observed: p₀>pₙ.

The pressure and the temperature drop in a Laval nozzle is described by the following equation: p₀/pₙ=(T₀/Tₙ)^{γ/(γ-1)}, γ is the adiabatic exponent which, for an ideal gas, is determined as the ratio of heat capacities at a constant pressure and volume. Therefore, by changing the p₀/pₙ—ratio it is possible to control the T₀/Tₙ—ratio and to freeze the formation of nanoparticles, which was initiated by high-temperature plasma chemical reactions, and to finish the nanoparticle synthesis at a temperature, at which a desired product should be obtained. In this way, it is possible to fabricate nanoparticles with a given chemical composition and purity.

If the movement of liquid or gas through the nozzle is assumed as isoentropic and stationary, the following relationship
(v²−c²)dv/v=c²dS/S
may be written for pressure p, speed v, density ρ, and sound velocity c in an average cross section of the nozzle on the basis of the Euler's equation: Vdv/dx=ρ⁻¹dp/dx (where x is a coordinate in the axial direction of the nozzle), the continuity equation (ρcS=const), and the expression of sound velocity: c²=dp/dρ.

It can be seen from the above expression that at v<c (subsonic flow along the nozzle) the sign of dv is opposite to the sign of dS, i.e., for increase in the speed of flow (dv>0), the cross sectional area of the nozzle in the x direction should decrease (dS<0), while at supersonic flows (v>c) of the fluid through the nozzle, dv and dS should have the same signs. In other words, for increase of the speed (dv>0) of the flow, the cross-sectional area of the nozzle in the direction of the longitudinal axis of the nozzle should also be increased. Physically, this is associated with the fact that at supersonic speeds, under the effect of compressibility of gases, density of gas drops faster than the growth of speed in the axial direction of the nozzle, and, in view of the continuity equation, in order to compensate for the rapid drop of the density, it is necessary to increase cross sectional area S. If v=c, then dS=0, and function S(x) assumes its extreme (minimal) value. Thus, a subsonic nozzle should have a converging shape (portion 36a of the Laval nozzle in FIG. 2).

The maximal speed that can be achieved in the converging nozzle is equal to the sound velocity and is reached in its outlet (the narrowest) cross section. The supersonic nozzle, which is the aforementioned Laval nozzle, has a profile that first converges and then diverges (the aforementioned converging/diverging shape). Pressure pₙ in the outlet cross section of the subsonic nozzle is always equal to pressure pₑ of the surrounding environment into which the flow exits from the nozzle (pₙ=pₑ). It should be noted that pₑ is not necessarily the atmospheric pressure since the nozzle may eject the flow into a vacuum chamber. As p₀ increases and pₑ is constant, the speed vₙ in the outlet cross section of the subsonic nozzle first increases, but becomes constant and does not grow further when p₀ reaches a certain predetermined value. This phenomenon is called crisis of flow. After the crisis, an average speed of exhaust of flow from a subsonic nozzle is equal to a local sound velocity (v=c) and is called critical velocity. In this case, all parameters of the fluid in the outlet cross section of the nozzle are called critical, while the nozzle is called “sonic nozzle”.

In a supersonic nozzle, critical is its most narrow cross section. The curve that characterizes the transfer from subsonic to supersonic speed (line v=c) is located in the area of the minimal cross section of the nozzle. Therefore, in the critical section the average speed is always close to the sound velocity. A relative speed vₙ/c=M_{c} and relative pressure p_{c}/p₀ in the outlet cross section of a supersonic nozzle depend only on a ratio of the outlet cross section area Sₙ to the area of the critical cross section S_{cr} and do not depend in a wide range on variations of the relative pressure p_{c}/p₀.

Variation of speed in the axial direction of the nozzle is determined by the law of variation of the area S(x). A profile of the nozzle, i.e., a type of S(x) function, can be defined on the basis of theories of bi-directional and three-directional flows in nozzles. Solution of equations in these theories is based on differential equations of gaseous dynamics with appropriate boundaries and initial conditions. Since in reality variations of speed of flow in the axial direction depend on such factors as friction, heat exchange between the working medium and the nozzle walls, the presence of solid particles in the flow, etc., solution of the aforementioned equations is extremely complicated, and therefore the final profile of the nozzle is determined experimentally. In other words, the process optimal for specific chemical reactions that occur in the apparatus, as well as the optimization of the formation of nanoparticles can be achieved only at a predetermined geometry of the nozzle 36.

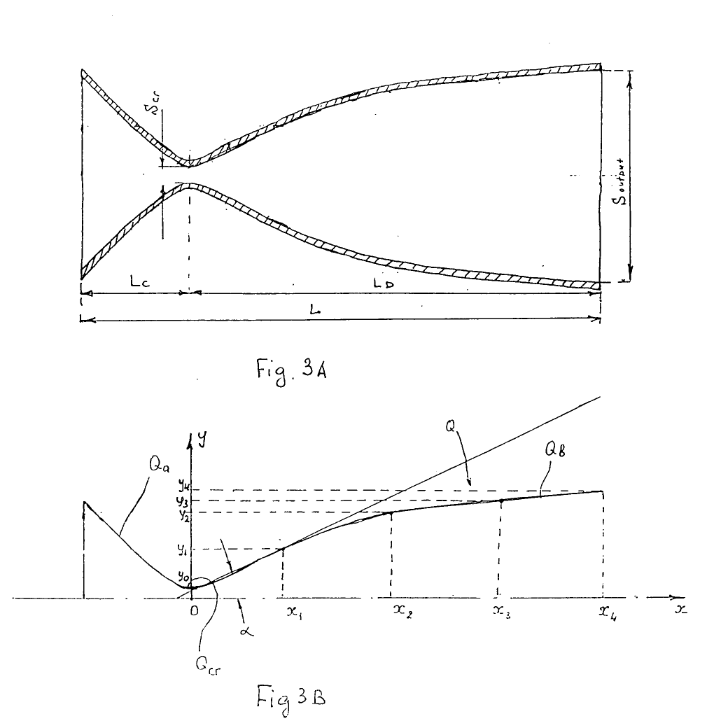

The profile of the nozzle 36 of the present invention is shown in FIGS. 3A and 3B and is based on the principle of optimization of the quenching process developed by the applicant for apparatuses of the type shown in FIG. 1. FIG. 3A is a longitudinal sectional view of the Laval nozzle with an optimized profile. FIG. 3B illustrates a profile curve Q of the Laval nozzle 36 which is presented in an orthogonal coordinate system X, Y, where axis X coincides with the longitudinal axis of the nozzle 36.

The profile Q consists of a converging portion Qₐ and a diverging portion Q_{b}, which merge through a critical cross-sectional area Q_{cr}. The center of coordinates O is located on axis X in the critical cross section which corresponds to a point on the profile that has coordinates X=0 and Y=Y₀. Let us chose four characteristic cross sections of the nozzle 36 which are equally spaced along axis X-X and are characterized by the following coordinates: X₁, Y₁; X₂, Y₂; X₃, Y₃; and X₄, Y₄. The last point (X₄, Y₄) corresponds to an outlet cross section of the Laval nozzle 36.

The applicants have found that the nozzle 36 has most optimal profile Q, when on the diverging portion Q_{b} is presented by a convex curve that has an inflection point (X₁, Y₁) that has abscissa coordinate of about ⅙ to ½ of the coordinate X₄ of the curve portion Q_{b}. A tangent R to the inflection point (X₁, Y₁) forms with the abscissa axis an angle α within the range of 7.5° and 42°. A preferable angle is 25°. In fact, the number of selected cross sections is not necessarily four and depends on the coordinated of the inflection point. The greater are coordinates of the inflection point, the smaller is the number of the cross sections selected for optimization of the nozzle geometry. For the coordinates of the point (X₁, Y₁) equal to about ¼ of the coordinates of the outlet cross section, a sufficient number of cross sections is four. In the case of optimization of the nozzle geometry by selecting four cross sections, the most optimal conditions are the following:
S₄/S_{cr} is within the range of 240 to 70, preferably about 140;
S₃/S_{cr} is within the range of 160 to 65, preferably about 120;
S₂/S_{cr} is within the range of 140 to 60, preferably about 100;
S₁/S_{cr} is within the range of 120 to 50, preferably about 40.

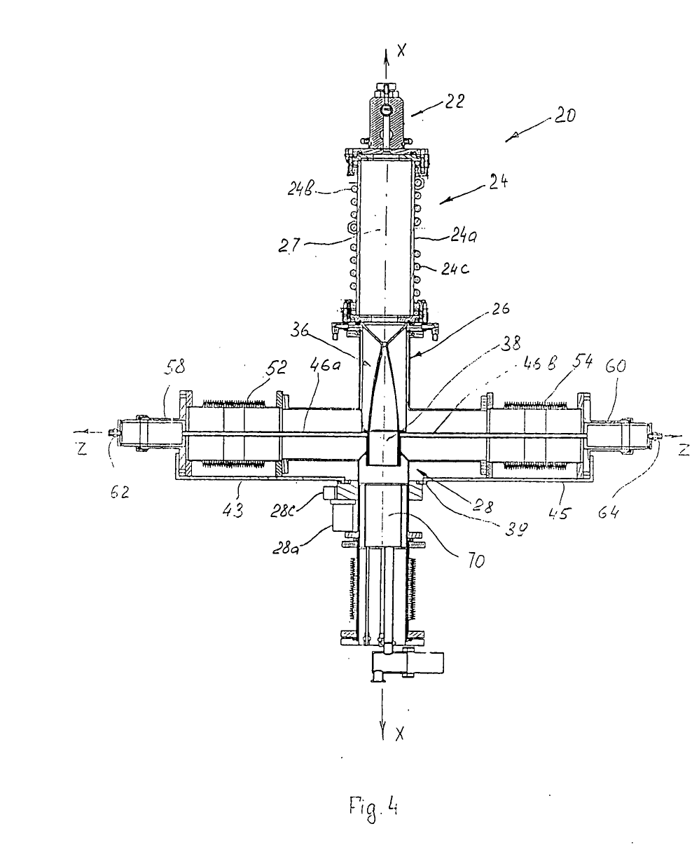

The aforementioned optimal conditions were determined for the case when the flow from the Laval nozzle 36 is emitted into an environment that is maintained under a pressure within the range of 10 to 100 mTorr, which in this embodiment has to be maintained in the interior of the housing 26 (FIG. 4). In other words, the nozzle 36 emits the jet into the zone of a reduced pressure. The reason for which the reduced pressure is selected within the range of 10 to 100 mTorr, will be explained below.

It is understood that the specific optimization ranges of the nozzle geometry given above does not limit the scope of application of the invention since it was conduced for the case of manufacturing of nanoparticles of molybdenum oxides or similar metal oxides.

What is common for any nozzle profiles optimized by the method of the invention is that they all are represented by a convex curve with the curvature outward from axis X, that they have an inflection point in the first half of the profile from the critical cross section, and that ratios of areas of the selected cross sections to the area of the critical cross section should fall into specific ranges with optimal values depending on the specific conditions of the nanoparticle formation process. It should be noted that the aforementioned ratios are dimensionless and within certain limits are applicable to nozzles of any dimensions. Another common feature is that the angle of a tangent to the point of inflection relative the longitudinal axis of the nozzle is selected within a predetermined range.

FIGS. 4-6—Nanoparticle Shielding and Entrapment Unit

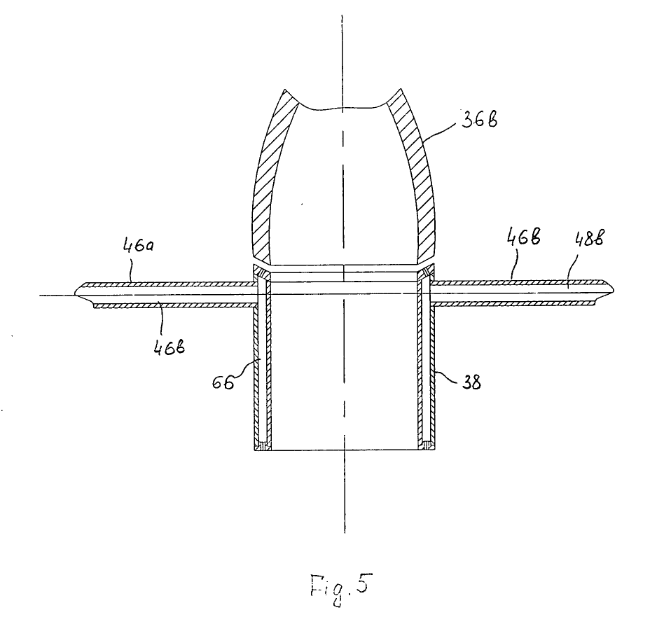

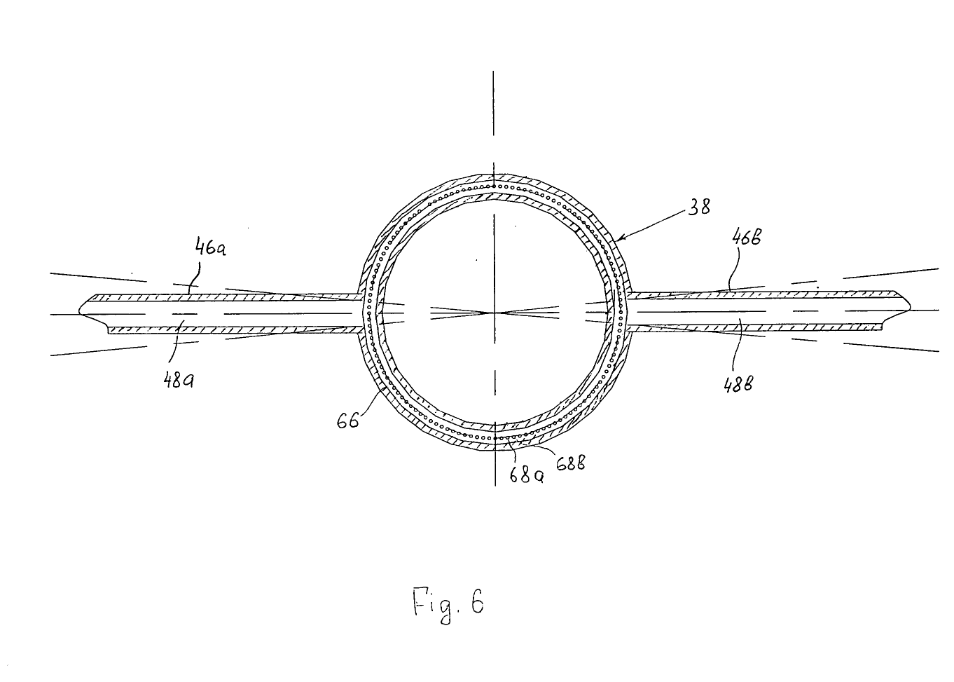

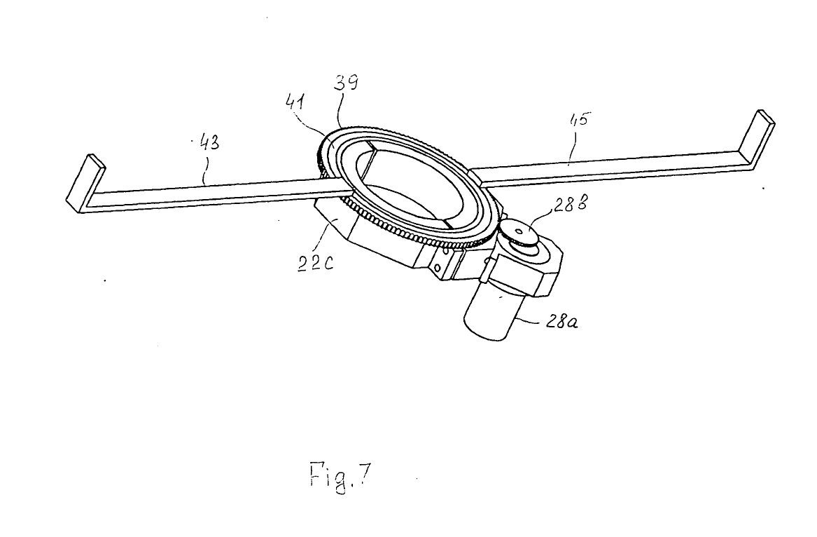

The nanoparticle shielding and entrapment unit 28 (hereinafter referred to as “entrapment unit”), which is shown in FIG. 4, is another unique feature of the method and apparatus of the present invention. FIG. 4 is a sectional view of the apparatus in the X-Z plane of FIG. 1. The entrapment unit 28 is an important part of any nanoparticle manufacturing apparatus and, as has been mentioned above, a disadvantage of the known nanoparticle collection units is their low efficiency and a high coefficient of losses. The entrapment unit 28 of the apparatus 20 is combined with the outlet portion of the Laval nozzle 36. More detailed view of the unit 28 is shown in FIG. 5, which is a fragmental side view, and in FIG. 6, which is a top view of the swinging shower ring 38. More specifically, the entrapment unit 28 comprises a swinging shower ring 38 that is slindingly fit onto the outer surface at the output end of the diverging portion 36b of the Laval nozzle 36 so that the ring 38 is limited against axial movement but can perform swinging motions with a predetermined frequency around the longitudinal axis X-X (FIG. 1) of the nozzle 36. These swinging motions are provided by means of a twist drive mechanism shown in FIG. 7. The mechanism consists of a gear ring 39, which is rotatingly supported by the outer surface of the housing 26 on a bearing 41. The gear ring is engaged with the drive gear 28b (FIGS. 1 and 7). The drive gear 28b is driven into rotation from the reversible servomotor 28a, so that rotation of the servomotor 28a in forward and reverse directions will cause swinging motions of the gear ring 39 by several degrees. The gear ring rigidly supports arms 43 and 45, which extend radially outwardly from the gear ring 39 in diametrically opposite positions. As shown in FIG. 4, the radial arms 43 and 45 support on their distal ends 43a, 43b oil reservoirs 58 and 60 (FIGS. 1 and 4), which are supplied with oil via flexible oil supply tubes 62, 64, respectively. The reservoirs 58 and 60 communicate with outer ends of through central openings 48a, 48b of transverse rods 46a and 46b (FIGS. 5 and 6), which are arranged along axis Z-Z (FIG. 1).

It is important to note that, in order to protect nanoparticles from contamination, it is necessary to minimize sliding motions of parts in the interior of the apparatus and thus to exclude formation of products of wear that could contaminate the nanoparticles. That is why swinging motions were used in the drive mechanism of the shower ring rather than full-revolution motions such as eccentrics, or the like.

As shown in FIG. 5, the inner ends of the central openings 48a, 48b are connected to a circular manifold channel 66 formed in the swinging ring 38 (FIGS. 4, 5, and 6). The swinging ring 38 has a plurality of circumferentially spaced through perforations 68a, 68b, . . . which are connected to the manifold channel 66 and are arranged parallel to the axis X-X. It is understood that when the oil is supplied to ring 38 under pressure through the central openings 48a, 48b, the oil flows down from the perforations 68a, 68b, . . . and under ideal conditions should form a cylindrical oil flow composed of discrete oil drops. A portion of the oil under pressure will flow up through the perforations 68a, 68b, . . . and form a sliding oil bearing between the mating surfaces of the ring 38 and the outlet part of the Laval nozzle portion 36b.

The rods 46a and 46b are located in a cross-like housing 26 (FIGS. 1 and 4) which is stationary and integral with the housing of the Laval nozzle 36. Since the rods 46a, 46b perform swinging motions and in view of the fact that the housing 26 is stationary, the rods 46a, 46b are coupled with the housing 26 via bellow-type seals 52 and 54, which allow the rods 46a, 46b to move relative to the housing without violating hermeticity of the apparatus interior. It is understood that during operation of the oil entrapment unit 28, the discrete drops of the oil shower emitted from the swinging ring will be twisted and flow along serpentine trajectories. This is important for preventing aggregation of individual drops. The oil is intended for collecting, i.e., entrapment of nanoparticles exhausted from the Laval nozzle 36, while a discrete nature of the cylindrical oil shower or barrier formed by the oil drops around the flow nanoparticle will allow passage of the gas, that has been admitted into the RF reactor 24, in the outward direction from the flow that passes through the Laval nozzle 36 and the entrapment unit 28 to the product collection unit 30 (FIGS. 1 and 2).

As has been mentioned, the reduced pressure in the vicinity of the twisted oil shower is within the range of 10 to 100 mTorr. One can think that the quenching process can be improved by reducing the pressure in the product entrapment unit 28. However, as has been mentioned in the description of the prior art, the main reason of the loss of nanoparticles in the processes similar to the process of the present invention is associated with the use of vacuum pumps that take away a significant part of nanoparticles which otherwise have to be collected by filters. In order to alleviate this problem, the apparatus of the present invention is provided with the aforementioned oil shower that, in addition to the function of entrapment of the nanoparticles for delivery to the particle collection container 70, forms a shield for preventing the nanoparticles from flying outside the central area surrounded by this oil shield. Furthermore, as has been described above, the discrete oil particles that form the oil shield, are twisted due to the above-described swinging motions of the shower ring 38. These motions generate a pulsed vortex motions in the direction of axis X-X in the gas-oil mixture of the nanoparticle entrapment unit. It has been found that the formation of such a vortex is most efficient when the reduced pressure in the housing 26 is within the range of 10 to 100 mTorr. This condition is provided by evacuating the fluid from the interior of the housing 26 by a vacuum pump (not shown) via a pipe 49a through a valve 49b (FIG. 2). It is known that pressure inside a vortex is always lower than on the periphery. Therefore, the nanoparticles contained in the entrapment unit 28 are concentrated near the longitudinal axis of this unit and move in the direction towards the product collection unit.

FIG. 4—Product Collection Unit

The product collection unit is the next in the downstream direction of the flow after the entrapment unit 28. It comprises a cylindrical container 70 with water-cooled walls that is sealingly connected to the outlet end of the entrapment unit 28. The oil shower 72 (FIG. 4) that is formed by the downwardly directed suspension of oil with the entrapped nanoparticles merely pours down into the container 70, wherefrom the dosed portions of the oil with entrapped nanoparticles are dispensed into oil cups 72a, 72b, . . . . (FIG. 1). As has been mentioned earlier, the nanoparticles are stored in oil as a medium that preserves the particles in their active state, prevents them from aggregation into larger particles, and protects them from reactions with other substances.

In the case when the apparatus 20 of the invention is a machine of a continuous action (FIG. 1), the cups 72a, 72b, . . . can be loaded onto a conveyor 74 by an end effector 76 of the industrial robot 78 from a magazine (not shown) and filled from the container 70 via a metering valve 80 (FIG. 4) installed on the outlet end of the container 70.

FIGS. 1-7—Operation

In operation, the aqueous solution or gas that contains a source of nanoparticle material is supplied under pressure to the plasma torch initiator 22 (FIGS. 1 and 2). For example, the DC plasma torch initiator 22 may be loaded with an aqueous solution of a molybdenum salt with a buffer gas or a mixture of gas with a precursor of the nanoparticle material. When the working medium passes through the arc-discharge area of the plasma torch imitator 22, it is heated to a high temperature, ionized to form a plasma, and the plasma is injected into the RF reactor 24 (FIGS. 1 and 2). This initial plasma discharge ignites the main plasma volume 27 inside the cylindrical body 24a. The plasma 27 is sustained inside the cylindrical body 24a under a pressure of about 2.5 atm, and the gaseous temperature in the center of the plasma volume plasma may reach 10000° C. The plasma is maintained under such temperature and is sustained in the reactor 24 under the effect of the RF electromagnetic energy (pumping) generated by the winding 24b and 24c. At the above pressure (maintains) the plasma inside the cylindrical body 24a in the state of equilibrium (FIG. 2). The plasma 27 forms nanoparticles from molecules of the precursor that was injected by the DC plasma torch initiator 22 and is contained in the plasma. In order to fix the nanoparticle dimensions, the flow of gas with nanoparticles is directed to the Laval nozzle section 36 (FIGS. 1 and 2).

In the Laval nozzle section 36 the nanoparticles are subjected to quenching that is achieved due to jumpewise decrease of the flow temperature and pressure resulting from adiabatic expansion in the diverging portion 36b of the Laval nozzle unit 36. In fact, the thermalization zone occupies the interior volume of the diverging portion 36b of the Laval nozzle and a portion of the volume in the nanoparticle entrapment unit 30.

Since the flow of the gas with nanoparticles is surrounded by the oil shower shield formed by the twisted jets emitted from the perforated ring 38 (FIG. 6) driven into swinging motions from the motor 28a via the driving gear 28b and the gear ring 39, the nanoparticles are concentrated near the longitudinal axis of apparatus 20 and move in the direction towards the product collection unit 30 (FIGS. 1 and 2). Furthermore, as has been described above, the twisted oil drops prevent the nanoparticles from flying radially outwardly from the surrounding cylindrical body of the oil shield. The oil with the collected nanoparticle flows down into the container 70 of the product collection unit 30, wherefrom it is dispensed into individual storage oil cups 72a, 72b, . . . . After filling with the nanoparticle-containing oil, the cups can be removed from the conveyor manually or with the use of a mechanical arm of the industrial robot 32 equipped with the end effector 76.

A method of the invention comprises the steps of: providing an apparatus for manufacture of nanoparticles comprising a DC plasma torch initiator, an RF plasma reactor connected to the plasma torch initiator, a Laval nozzle unit with a specific optimized profile of the outlet part of the nozzle connected to the output of the RF reactor, a thermalization zone in the outlet part of the Laval nozzle, a nanoparticle shielding and entrapment unit that is associated with the output of the Laval nozzle, a product collection unit for collecting the obtained nanoparticles received from the nanoparticle shielding and entrapment unit, and, if necessary, a unit for loading the product into individual cups; supplying a nanoparticle precursor material together with a carrying fluid into the plasma torch initiator under a pressure; initiating an arc discharge in the plasma torch initiator and heating the supplied material to a high temperature by passing it through the zone of high temperature thus ionizing the supplied material and igniting an initial plasma torch; feeding the initial plasma jet to the RF plasma reactor to form a main plasma volume that is sustained in the reactor under the effect of the RF electromagnetic energy supplied by the RF windings of the reactor; forming nanoparticles from molecules of the precursor contained in the plasma in the RF reactor; passing the flow of the fluid with nanoparticles to the Laval nozzle unit for thermalization; providing a barrier for the nanoparticles that prevents them from flying outwardly from the central part of the flow by forming a cylindrical oil shower consisting of discrete drops of oil and surrounding the aforementioned mixture starting from the output of the Laval nozzle; imparting to the aforementioned drops twisting motions so that the carrying fluid can pass through the oil shower while the nanoparticles are prevented from said passage and entrapped by the oil drops; generating a zone of a reduced pressure in the central part of the flow in the zone of thermalization by selecting frequency of said twisting motions that generate a vortex in the area surrounded by the oil shower; and moving the oil with the entrapped nanoparticles towards the product dispensing unit.

Thus it has been shown that the present invention provides an apparatus for manufacturing nanoparticles that is characterized by improved conditions for the formation and collection of nanoparticles, wide range of nanoparticle types and dimensions, production efficiency, suitability for industrial conditions, and efficient collection of the produced nanoparticles in a suspension with oil. The invention also provides a method of manufacturing nanoparticles in a wide range of dimensions and types with high production efficiency.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the precursor may be different from molybdenum oxide. The twisted motion can be imparted to the oil shower ring by any other drive mechanism. Nanoparticles can be emitted from the Laval nozzle to the area of atmospheric pressure. The product in the form of a suspension of oil with nanoparticles can be loaded into storage cups manually or with the use of any other automatic or semiautomatic mechanism different from the mechanical arm with the end effector shown and described in the application. Within the scope of the patent claims given below, the Laval nozzle may have different profiles.

1. An apparatus for manufacture of nanoparticles comprising:
a plasma torch initiator for receiving a fluid that contains a precursor of the material of said nanoparticles, said plasma torch having means for initiation of an initial plasma torch;
an RF plasma reactor for the formation of a main plasma volume from said initial plasma (torch) jet, said RF plasma reactor having means for the formation and sustaining said main plasma volume in which said nanoparticles are formed, said RF plasma reactor having an outlet;
a Laval nozzle having a longitudinal axis, an interior, and comprising a converging portion connected to said outlet of said RF plasma reactorand a diverging portion which is a continuation of said converging portion and which has a Laval nozzle outlet on the side opposite to said RF reactor; and
a nanoparticle collection unit connected to said Laval nozzle outlet;
a thermalization zone comprising a part of said interior of said Laval nozzle and a portion of said nanoparticle collection unit, said thermalization zone having a central zone and is intended for quenching said nanoparticles that are admitted to said thermalization zone together with said fluid from said Laval nozzle for quenching said nanoparticles and for adiabatic expansion of said fluid upon exiting from said converging portion of said Laval nozzle;
said Laval nozzle having a curvilinear profile optimized with regard to conditions of said quenching, said nanoparticle collection unit having means for creating a cylindrical oil shower that consists of discrete oil drops, surrounds said central zone, entraps said nanoparticles, and prevents said nanoparticles from flying in the radial outward direction from said central zone through said oil shower while passing out said fluid.

2. The apparatus of claim 1, wherein said means for the formation and sustaining said main plasma volume comprise electromagnetic field generation winding means.

3. The apparatus of claim 2, wherein said electromagnetic field generation winding means comprise electromagnetic windings operating on different frequencies.

4. The apparatus of claim 3, wherein said electromagnetic windings are two electromagnetic windings operating on frequencies of 13.56 MHz and 27.12 MHz, respectively.

5. The apparatus of claim 1, wherein said Laval nozzle having a critical cross section in a direction perpendicular to said longitudinal axis at a point where said converging portion merges with said diverging portion, said curvilinear profile comprising a convex curve with the curvature on said diverging portion directed outward from said longitudinal axis, said convex curve having an inflection point in the first half of said convex curve from said critical cross section, said convex curve having characteristic cross sections in selected points on said longitudinal axis, ratios of areas of said characteristic cross sections to the area of said critical cross section falling into specific ranges, an angle of a tangent to said inflection point being selected within a predetermined range.

6. The apparatus of claim 5, wherein said specific ranges satisfies the following conditions:
S₄/S_{cr} is within the range of 240 to 70,
S₃/S_{cr} is within the range of 160 to 65,
S₂/S_{cr} is within the range of 140 to 60, and
S₁/S_{cr} is within the range of 120 to 50,
where the number of said selected points is four, S₁, S₂, S₃, and S₄ are said areas of said characteristic cross sections in said four selected points, respectively, and Scr is said area of said critical cross section.

7. The apparatus of claim 6, wherein said predetermined range of said angle of a tangent to said inflection point is 7.5° to 42°.

8. The apparatus of claim 4, wherein said Laval nozzle having a critical cross section in a direction perpendicular to said longitudinal axis at a point where said converging portion merges with said diverging portion, said curvilinear profile comprising a convex curve with the curvature on said diverging portion directed outward from said longitudinal axis, said convex curve having an inflection point in the first half of said convex curve from said critical cross section, said convex curve having characteristic cross sections in selected points on said longitudinal axis, ratios of areas of said characteristic cross sections to the area of said critical cross section falling into specific ranges, an angle of a tangent to said inflection point being selected within a predetermined range.

9. The apparatus of claim 8, wherein said specific ranges satisfies the following conditions:
S₄/S_{cr} is within the range of 240 to 70,
S₃/S_{cr} is within the range of 160 to 65,
S₂/S_{cr} is within the range of 140 to 60, and
S₁/S_{cr} is within the range of 120 to 50,
where the number of said selected points is four, S₁, S₂, S₃, and S₄ are said areas of said characteristic cross sections in said four selected points, respectively, and S_{cr} is said area of said critical cross section.

10. The apparatus of claim 9, wherein said predetermined range of said angle of a tangent to said inflection point is 7.5° to 42°.

11. The apparatus of claim 1, wherein said means for creating said cylindrical shower comprises a shower ring having circumferentially arranged perforations, means for the supply of oil to said perforations, and means for swinging said shower ring with a predetermined frequency.

12. The apparatus of claim 4, wherein said means for creating said cylindrical shower comprises a shower ring having circumferentially arranged perforations, means for the supply of oil to said perforations, and means for swinging said shower ring with a predetermined frequency.

13. The apparatus of claim 5, wherein said means for creating said cylindrical shower comprises a shower ring having circumferentially arranged perforations, means for the supply of oil to said perforations, and means for swinging said shower ring with a predetermined frequency.

14. The apparatus of claim 8, wherein said means for creating said cylindrical shower comprises a shower ring having circumferentially arranged perforations, means for the supply of oil to said perforations, and means for swinging said shower ring with a predetermined frequency.

15. The apparatus of claim 9, wherein said means for creating said cylindrical shower comprises a shower ring having circumferentially arranged perforations, means for the supply of oil to said perforations, and means for swinging said shower ring with a predetermined frequency.

16. The apparatus of claim 9, wherein said thermalization zone is under pressure below the atmospheric.

17. The apparatus of claim 1, wherein said a main plasma volume is under pressure above the atmospheric pressure while said thermalization zone is under pressure below the atmospheric pressure.

18. The apparatus of claim 6, wherein said a main plasma volume is under pressure above the atmospheric pressure while said thermalization zone is under pressure below the atmospheric pressure.

19. The apparatus of claim 9, wherein said a main plasma volume is under pressure above the atmospheric pressure while said thermalization zone is under pressure below the atmospheric pressure.

20. A method of manufacturing nanoparticles comprising the steps of:
passing a carrying fluid with a nanoparticle precursor through an RF plasma volume for heating said fluid with said nanoparticle precursor to a high temperature and for synthesizing said nanoparticles;
passing said fluid with nanoparticles through a Laval nozzle having a converging portion and a diverging portion for subjecting said fluid with said nanoparticles to jumpwise adiabiatic expansion in said diverging portion for thermalization of said nanoparticles, at least said diverging portion having a curvilinear profile optimized with respect to conditions of said thermalization;
foming a thermalization zone in at least a part of said diverging portion of said Laval nozzle and in a nanoparticle entrapment unit that follow said Laval nozzle;
surrounding a zone that contains said fluid with said nanoparticles in said nanoparticle entrapment unit by a cylindrical oil shower composed of discrete drops of oil;
imparting to said oil shower swinging motions for generating a vortex in said zone surrounded by a cylindrical oil shower for causing said fluid with said nanoparticles to move through said thermalization zone to a nanoparticle collection unit which is located below said thermalization zone;
allowing said fluid to fly outward from said thermalization zone through said oil shower while entrapping said nanaparticlles in said discrete oil drops; and
collecting said discrete oil drops with nanoparticles entrapped therein in said nanoparticle collection unit.

21. The method of claim 17, wherein said thermalization zone is maintained under pressure below the atmospheric pressure.
